(19) United States
(12) Patent Application Publication
(10) Pub. No.: US 2026/0018936 A1
(43) Pub. Date: Jan. 15, 2026

(54) WIRELESS POWER TRANSMITTER AND RECEIVER SYSTEM

(71) Applicant: Ahmad L.D. Glover, Hampton, VA (US)

(72) Inventor: Ahmad L.D. Glover, Hampton, VA (US)

(21) Appl. No.: 18/769,236

(22) Filed: Jul. 10, 2024

(51) Int. Cl. H02J 50/20; H02J 50/00; H04B 1/40

(52) U.S. Cl. CPC H02J 50/20; H02J 50/001; H04B 1/40

(57) ABSTRACT

Disclosed herein is a wireless power receiver system which includes a programable gain power amplifier configured to receive an energy input derived from the electromagnetic energy source and direct an amplified energy output signal into a power harvesting circuit within an optimal input range of the power harvesting circuit at which the amplified energy output signal is converted into DC current at an efficiency of greater than or equal to about 50%. A wireless power bank having a plurality of wireless power receiver systems is also disclosed.

### FIELD

This application relates to a wireless charging system for charging an electronic device.

### BACKGROUND

Technology related to electromagnetic energy waves, ranging from radio frequency, (RF) to ultraviolet light and beyond, has enabled transformative changes in our society via innovations such as wireless communication, radio wave sensing and wireless power transfer.

In relation to the power needs of mobile devices, such technology offers a new vision of wirelessly powered world. This can be realized through a wireless power transmission grid, which could be applied for a range of applications from traditional mobile phones to wearable health and fitness devices, implantable devices, and other Internet of Things (IoT) type devices. This vision is specially becoming true on account of ever reducing power usage of modern electronics and innovations in rechargeable batteries.

However, currently available technology for harvesting DC power from an electromagnetic signal, e.g., an infrared light signal, a visible light signal, a UV light signal, an RF signal, and/or the like, results in a significant loss of the available power received by the system due to mismatched inputs and outputs of various components. There is a need in the art for an efficient wireless powering harvesting solution to receive, convert and store electrical power suitable for recharging and/or powering electronic devices.

### SUMMARY

In an embodiment, a wireless power receiver system comprises a programable gain power amplifier configured to receive an energy input derived from the electromagnetic energy source, and direct an amplified energy output signal into a power harvesting circuit within an optimal input range of the power harvesting circuit at which the amplified energy output signal is converted into DC current at an efficiency of greater than or equal to about 50%.

In embodiments, a wireless power receiver system comprises an electromagnetic energy receiver configured to receive a wireless electromagnetic energy signal from an external power source, e.g., a transmitter, an emitter, a laser, and/or the like, physically separated from the electromagnetic energy receiver by a distance of greater than about 10 cm; the electromagnetic energy receiver in electrical communication with an impedance matching network configured to output energy into an input of a programable gain power amplifier having an independent power source; the programable gain power amplifier configured to direct an amplified energy output signal into a plurality of power harvesting circuits through a power divider circuit; wherein a DC power output of each of a plurality of power harvesting circuits are combined and directed into an energy management circuit configured to direct the DC power into an electrical storage device; the electrical storage device configured to output energy to an external electrical device through a wired electrical connection; wherein the programable gain power amplifier is configured to produce the amplified energy output signal within an optimal input range of the power harvesting circuits at which the amplified energy output signal is converted into DC power at an efficiency of greater than or equal to about 50%.

In embodiments, a wireless power bank comprises a plurality of wireless power receiver systems, each comprising: an electromagnetic energy receiver configured to receive a wireless electromagnetic energy signal from an external power source physically separated from the electromagnetic energy receiver by a distance of greater than about 10 cm; the electromagnetic energy receiver in electrical communication with an impedance matching network configured to output energy into an input of a programable gain power amplifier having an independent power source; the programable gain power amplifier configured to direct an amplified energy output signal into a plurality of power harvesting circuits through a power divider circuit; wherein the programable gain power amplifier is configured to produce the amplified energy output signal within an optimal input range of the power harvesting circuits at which the amplified energy output signal is converted into DC power at an efficiency of greater than or equal to about 50%; wherein:
i) a DC power output of each of a plurality of power harvesting circuits of each of the plurality of wireless power receiver systems are combined and directed into a single energy management circuit configured to direct the DC power into a single electrical storage device; or
ii) the DC power output of each of the plurality of power harvesting circuits of each of the plurality of wireless power receiver systems are directed into an energy management circuit, each of the outputs of the energy management circuits are combined and directed into a single electrical storage device; and wherein the electrical storage device configured to output energy to an external electrical device through a wired electrical connection.

### BRIEF DESCRIPTION OF THE DRAWINGS

A wide variety of potential practical and useful embodiments will be more readily understood through the following detailed description of various embodiments, with reference to the accompanying drawings in which:

FIG. 1 is a block diagram depicting a wireless power receiver system according to an embodiment disclosed herein.

FIG. 2A is a block diagram of a wireless power bank according to an embodiment disclosed herein.

FIG. 2B is a block diagram of a wireless power bank according to another embodiment disclosed herein.

FIG. 3 is a block diagram of a wireless power transmitter system according to embodiments disclosed herein.

FIG. 4A is a perspective view depicting a wireless power transmitter system disposed within an enclosure according to embodiments disclosed herein.

FIG. 4B is a front on view depicting the wireless power transmitter system disposed within an enclosure depicted in FIG. 4A.

### DETAILED DESCRIPTION

It is to be understood that various embodiments of the present disclosure will be described with reference to the accompanying drawings. Accordingly, those of ordinary skill in the art will recognize that modifications, equivalents, and/or alternatives of the various embodiments described herein can be made without departing from the scope and spirit of the present disclosure. With regard to description of drawings, similar components may be marked by similar reference numerals.

For use herein, the expressions “have”, “may have”, “include”, “comprise”, “may include”, and “may comprise” indicate the existence of corresponding features (e.g., such as numeric values, functions, operations, or components) but do not exclude the presence of additional features.

As used herein, the expression “configured to” used herein may be used interchangeably with, for example, the expression “suitable for”, “having the capacity to”, “designed to”, “adapted to”, “made to”, or “capable of”. The term “configured to (or set to)” does not mean only “specifically designed to” in hardware. Instead, the expression “a device configured to” may mean that the device is “capable of” operating together with another device or other components. For example, an “electronic memory assembly” configured to (or set to) store data for subsequent retrieval, refers to any such memory module or modules, with the associated circuitry, power source, and programming which render it capable of performing the corresponding operation of storage and retrieval utilizing a generic-purpose processor (e.g., a central processing unit (CPU) or an application processor) which may perform corresponding operations by executing one or more software programs which are stored on the memory device.

The various illustrative logical blocks, modules and the like described in connection with the present disclosure may be implemented or performed with a general-purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The controller and/or processor and/or control circuits refer to a controlling system which may be a single purpose built circuit, a multiple purpose built circuit, and/or may include a processor and the related circuitry and components, e.g., power source, memory, storage, processors, coprocessors, gates, relays, other integrated circuits, software, and/or the like, necessary for its function. The processor may be responsible for managing general processing, including the execution of software stored on a machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may comprise a computer-readable medium having instructions stored (and/or encoded) thereon, the instructions being executable by one or more processors to perform the operations described herein and be embodied in a computer-program product.

The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object.

The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

In various embodiments of the present disclosure, the electronic components referred to in embodiments of the device are not limited to currently known devices but may include new electronic devices suitable for the intended purpose which are subsequently produced due to the development of new technologies.

In embodiments, a wireless power receiver system comprises a programable gain power amplifier configured to receive an energy input derived from the electromagnetic energy source and direct an amplified energy output signal into a power harvesting circuit within an optimal input range of the power harvesting circuit at which the amplified energy output signal is converted into DC current at an efficiency of greater than or equal to about 50%.

In some embodiments, the programable gain power amplifier is configured to direct the amplified energy output signal into the power harvesting circuit within an optimal input range of the power harvesting circuit at which the amplified energy output signal is converted into DC current at an efficiency of greater than or equal to about 65%. In some embodiments, the programable gain power amplifier is powered by an independent power source. In some embodiments, the programable gain power amplifier is configured to receive the energy input derived from the electromagnetic energy source from an electromagnetic energy receiver configured to receive a wireless electromagnetic energy signal from an external power source physically separated from the electromagnetic energy receiver by a distance of greater than about 10 cm. In some embodiments, the electromagnetic energy receiver is configured to receive a directed power beam from the external power source.

In embodiments, the electromagnetic energy receiver is in electrical communication with the energy input derived from the electromagnetic energy source of the programable gain power amplifier through an impedance matching network.

In embodiments, the output of the power harvesting circuit is directed into an energy management circuit configured to direct electrical energy into an electrical storage device, the electrical storage device configured to output energy to an external electrical device through a wired electrical connection. In embodiments, the electrical storage device comprises a battery. In embodiments, the electrical storage device comprises a capacitor.

In embodiments, the energy management circuit is further configured to direct power into the independent power source of the programable gain power amplifier.

In some embodiments, a wireless power receiver system comprises an electromagnetic energy receiver configured to receive a wireless electromagnetic energy signal from an external power source physically separated from the electromagnetic energy receiver by a distance of greater than about 10 cm, or greater than about 50 cm, or greater than about 100 cm; the electromagnetic energy receiver in electrical communication with an impedance matching network configured to output energy into an input of a programable gain power amplifier having an independent power source; the programable gain power amplifier configured to direct an amplified energy output signal into a plurality of power harvesting circuits through a power divider circuit; wherein a DC power output of each of a plurality of power harvesting circuits are combined and directed into an energy management circuit configured to direct the DC power into an electrical storage device; the electrical storage device configured to output energy to an external electrical device through a wired electrical connection; wherein the programable gain power amplifier is configured to produce the amplified energy output signal within an optimal input range of the power harvesting circuits at which the amplified energy output signal is converted into DC power at an efficiency of greater than or equal to about 50%. Accordingly, in embodiments, the programable gain power amplifier is utilized to optimize the input to the power harvesting circuits thereby improving the overall performance and efficiency of the system. In embodiments, the programable gain power amplifier is controlled by a receiver controller to optimize the input to the power harvesting circuits on a real-time basis based on the demand, available energy, and other operational conditions. In some embodiments, the energy management circuit is further configured to direct power into the independent power source of the programable gain power amplifier.

In embodiments a wireless power bank comprises a plurality of wireless power receiver systems according to embodiments disclosed herein, wherein a DC power output of each of a plurality of power harvesting circuits of each of the plurality of wireless power receiver systems are combined and directed into an energy management circuit configured to direct the DC power into an electrical storage device; or wherein the DC power output of each of the plurality of power harvesting circuits of each of the plurality of wireless power receiver systems are directed into an energy management circuit, each of the outputs of the energy management circuits are combined and directed into a single electrical storage device; wherein the electrical storage device is configured to output energy to an external electrical device through a wired electrical connection.

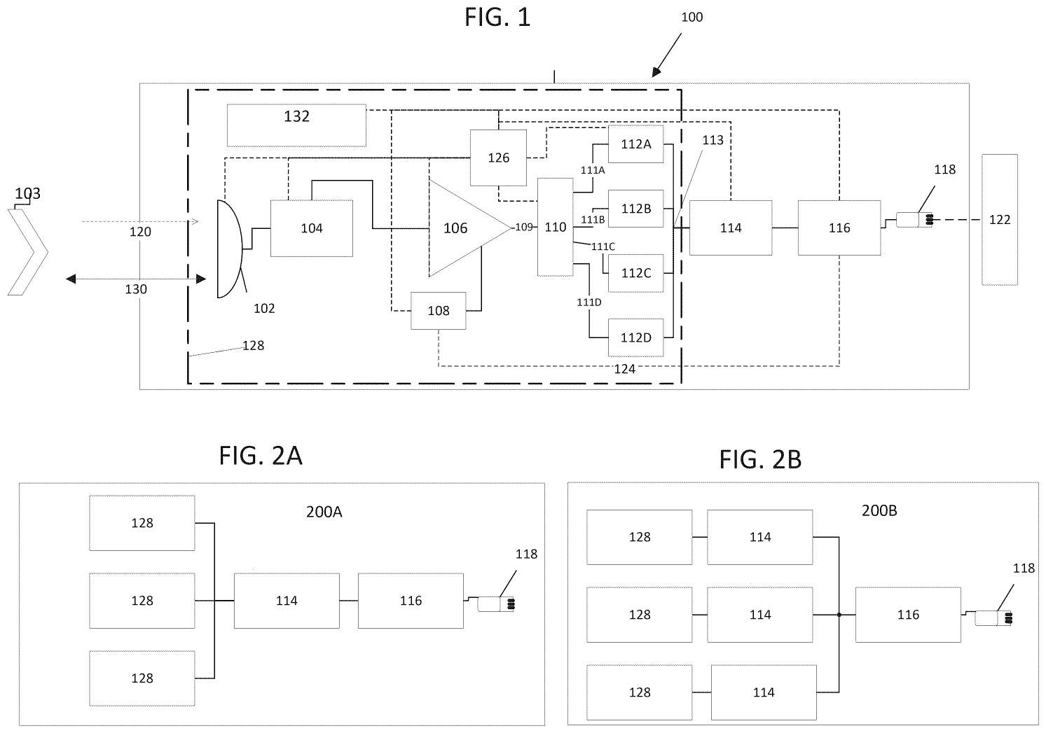

FIG. 1 is a block diagram depicting a wireless power receiver system 100 according to an embodiment. The wireless power receiver system 100 comprises an electromagnetic energy receiver 102 configured to receive a wireless electromagnetic energy signal 120 from a wireless power transmitter system 103 physically separated and not in physical contact with, i.e., touchless, from the electromagnetic energy receiver 102 by a distance 130 of greater than about 10 cm. The electromagnetic energy receiver is in electrical communication with an impedance matching network 104 configured to output energy into an input of a programable gain power amplifier 106 having an independent power source 108. The programable gain power amplifier 106 is configured to direct an amplified energy output signal 109 into a signal splitter, also referred to as a power dividing circuit 110, which then outputs each of the divided amplified energy signals 111A, 111B, 111C, 111D to a corresponding number of power harvesting circuits. Four (4) power harvesting circuits 112A, 112B, 112C, and 112D are shown in FIG. 1. However it is to be understood that any number of power harvesting circuits may be utilized.

The DC power output of each of a plurality of power harvesting circuits 112A-112D are then combined 113 and directed into an energy management circuit or controller 114 configured to direct the DC power into an electrical storage device 116. The electrical storage device 116 is configured to output energy to an external electrical device 122 through a wired electrical connection 118, which may be a hard-wired electrical connection or a removable or disengageable electrical connection such as a USB or other suitable connector. In some embodiments, the energy management circuit 114 is further configured to direct power from the electrical storage device 116 back into the independent power source 108 of the programable gain power amplifier 106, e.g., via 124.

In embodiments, the wireless power receiver system 100 further includes a wireless electronic communication system 132, configured to provide electronic communication between the receiver controller 126 and an external electronic device. In embodiments, the wireless electronic communication system 132 is configured for wifi communication, serial communication, e.g., bluetooth, and/or the like. The wireless electronic communication system 132 may be in electronic communication with the electromagnetic energy receiver 102 e.g., an antenna, or may include a separate or internal antenna.

In embodiments, a receiver controller 126 may be utilized to control one or more of the impedance matching network 104, the programable gain power amplifier 106, the independent power source 108, one or more of the power harvesting circuits 112A, 112B, 112C, and 112D, the energy management circuit or controller 114, the electrical storage device 116, the wireless electronic communication system 132, and/or the output of energy to an external electrical device 122.

The efficiency of the power harvesting circuits depends on the character of the input signal. In addition, the amount of DC current the power harvesting circuits can process or harvest from an electromagnetic energy signal is limited. The inventor has discovered that the output from the impedance matching network 104 is not in a form or within a proper range to allow the power harvesting circuit to function at an optimum level or with maximum efficiency. Furthermore, the limited capacity of power harvesting circuits limits the amount and efficiency of harvesting DC current (power) that may be extracted from an electromagnetic energy signal. While the programable gain power amplifier consumes power, it has been discovered that by configuring the programable gain power amplifier to produce the amplified energy output signal within an optimal input range of the power harvesting circuits, an overall improvement of system efficiency is achieved.

Accordingly, in embodiments, the programable gain power amplifier is configured to produce an amplified energy output signal at which the power harvesting circuit or converters operate at an efficiency of greater than or equal to about 50%, or greater than or equal to about 60%, or greater than or equal to about 70%.

In embodiments, the electromagnetic energy receiver 102 of the wireless power receiver system 100 comprises, or is an RF antenna configured to receive a wireless RF power signal from an external power source physically separated and not in physical contact with, i.e., touchless, from the RF antenna by a distance of greater than about 10 cm. The RF antenna is in electrical communication with an impedance matching network configured to output RF energy into an input of a programable gain RF power amplifier having an independent power source. The programable gain RF power amplifier is configured to direct an amplified RF energy output into a signal splitter, also referred to as a power dividing circuit, which then outputs each of the divided amplified RF energy signals to a corresponding number of RF to DC converters, wherein any number of RF to DC converters may be utilized. The DC power output of each of a plurality of RF to DC converters are then combined and directed into an energy management circuit or controller configured to direct the DC power into an electrical storage device. The electrical storage device is configured to output energy to an external electrical device through a wired electrical connection, which may be a hard-wired electrical connection or a removable or disengageable electrical connection such as a USB or other suitable connector. In some embodiments, the energy management circuit is further configured to direct power from the electrical storage device back into the independent power source of the programable gain RF power amplifier.

In embodiments, a controller may be utilized to control one or more of the impedance matching network, the programable gain RF power amplifier, the independent power source, one or more of the RF to DC converters, the energy management circuit, the electrical storage device, the serial communication system, and/or the output of energy to an external electrical device.

The efficiency of the RF to DC converters depends on the character of the input signal. In addition, the amount of DC current the RF to DC converters can process or harvest from an RF signal is limited. The inventor has discovered that the output from the impedance matching network is not in a form or within a proper range to allow the RF to DC converter to function at an optimum level or with maximum efficiency. Furthermore, the limited capacity of RF to DC converters limits the amount and efficiency of harvesting DC current (power) that may be extracted from a RF signal. While the programable gain RF power amplifier consumes power, it has been discovered that by configuring the programable gain RF power amplifier to produce the amplified RF energy output within an optimal input range of the RF to DC converters, an overall improvement of system efficiency is achieved.

Accordingly, in embodiments, the programable gain RF power amplifier is configured to produce an amplified RF energy output at which the RF to DC converter or converters operate at an efficiency of greater than or equal to about 50%, or greater than or equal to about 60%, or greater than or equal to about 70%.

In embodiments, the wireless power receiver system is configured to receive and harvest electrical energy from a broadcast electromagnetic energy beam having a broadcasting arc or beam width of less than 360° (for a unidirectional antenna), and less than 180° for a wall mounted or planer antennas. In embodiments, the beams are dynamically adjusted according to the distance of the wireless power receiver system from, the base charger, and/or the direction of movement of the intended wireless power receiver system. In embodiments, the broadcast electromagnetic energy beam directed to the intended wireless power receiver system receiver has a beam width of less than or equal to about 180°, or 90°, or 60°, or 55°, or 50°, or 45°, or 40°, or 35°, or 30°, or 25°.

In embodiments, the wireless power receiver system is configured to receive and harvest electrical energy from a directional electromagnetic energy beam having a beam width of less than about 20°. In embodiments, the directional electromagnetic energy beam or beams are dynamically adjusted according to the distance of the wireless power receiver system from the wireless power transmitter, and/or the direction of movement of the intended wireless power receiver system. In embodiments, the directed electromagnetic energy beam has a beam width of less than or equal to about 20°, or 15°, or 10°, or 5°.

In one embodiment, the wireless power receiver system is configured to harvest energy provided by a wireless charging system configured to broadcast or otherwise direct one or more electromagnetic energy beams to the wireless power receiver system, and may comprise antenna elements and associated circuitry, software and control systems for operating in frequency bands from about 20 KHz to about 50 KHz, and/or from about 150 MHz to about 900 MHz, and/or from about 900 MHz to about 1.8 GHZ, and/or from about 1.6 GHz to about 2.0 GHz, and/or from about 2.0 GHz to about 8.0 GHz, and/or from about 3 GHz to about 300 GHz. In embodiments, the wireless power receiver system is configured to harvest energy provided in frequency bands around 900 MHZ, 2.5 GHZ, 5.250 GHz, or 5.8 GHz. In embodiments, the antenna elements and associated circuitry, software and control systems are configured for operating in frequency bands within the “5G” range which include low-band, mid-band or high-band millimeter-wavelengths having frequencies from about 24 GHz up to 54 GHz, and/or mid-band 5G using microwave wavelengths having frequencies from about 2.3-4.7 GHZ, and/or high-band 5G wavelengths using frequencies of 24-47 GHz.

In embodiments, the wireless power receiver system is configured to harvest electromagnetic energy provided as an infrared signal, a visible signal, an ultraviolet signal, an RF signal source, or a combination thereof.

In embodiments, the wireless power receiver system according to one or more embodiments disclosed herein is configured to harvest energy from one or electromagnetic energy beams provided by an external wireless charging system over a distance of greater than about 10 cm, or 20 cm, or 30 cm, or 40 cm, or 50 cm, or 100 cm, or 5 m, or 10 m, or 50 m, convert the harvested energy into electrical energy, and direct the electrical energy into the electrical storage device.

In addition to the wireless power transmitter systems disclosed herein, suitable wireless power transmitter systems include those comprising at least one base multi point power and base multi point power charger (“base multi point power charger”), for providing wireless energy to at least one, preferably a plurality of untethered, spaced apart electronic devices that consume energy for a function other than charging or powering another device (“electronic devices”). These electronic devices are spaced away from the base multi point power charger. Preferably, the system comprises a plurality of the base multi point power chargers.

As shown in FIG. 2A, in embodiments, a wireless power bank 200A comprises a plurality of wireless power receiver subsystems 128 (see FIG. 1), each comprising an electromagnetic energy receiver 102 configured to receive a wireless electromagnetic energy signal 120 from an external power source via a wireless power transmitter system 103 physically separated from 122 the electromagnetic energy receiver 102 by a distance of greater than about 10 cm; the electromagnetic energy receiver 102 in electrical communication with an impedance matching network 104 configured to output energy into an input of a programable gain power amplifier 106 having an independent power source 108; the programable gain power amplifier 106 configured to direct an amplified energy output signal 109 into a plurality of power harvesting circuits 112A-D through a power divider circuit 110; wherein the programable gain power amplifier 106 is configured to produce the amplified energy output signal 109 within an optimal input range of the power harvesting circuits 112A-D at which the amplified energy output signal is converted into DC power at an efficiency of greater than or equal to about 50%. Each of the plurality of wireless power receiver subsystems 128 are combined and directed into an energy management circuit 114 configured to direct the DC power into an electrical storage device 116, and the electrical storage device 116 is configured to output energy to an external electrical device (see FIG. 1) through a wired electrical connection.

As shown in FIG. 2B, in embodiments, a wireless power bank 200B comprises a plurality of wireless power receiver subsystems 128 (see FIG. 1), each comprising an electromagnetic energy receiver 102 configured to receive a wireless electromagnetic energy signal 120 from a wireless power transmitter system 103 physically separated 130 from the electromagnetic energy receiver 102 by a distance of greater than about 10 cm; the electromagnetic energy receiver 102 in electrical communication with an impedance matching network 104 configured to output energy into an input of a programable gain power amplifier 106 having an independent power source 108; the programable gain power amplifier 106 configured to direct an amplified energy output signal 109 into a plurality of power harvesting circuits 112A-D through a power divider circuit 110; wherein the programable gain power amplifier 106 is configured to produce the amplified energy output signal 109 within an optimal input range of the power harvesting circuits 112A-D at which the amplified energy output signal is converted into DC power at an efficiency of greater than or equal to about 50%. Each of the plurality of wireless power receiver subsystems 128 further include an energy management circuit 114 configured to direct the DC power into an electrical storage device 116, the outputs of each energy management circuit 114 are combined and directed into the electrical storage device 116, which is configured to output energy to an external electrical device (see FIG. 1) through a wired electrical connection.

### Wireless Power Transmitter System

In embodiments, the wireless power transmitter system is configured to convert electrical energy from a power source, e.g., mains power, into an electromagnetic energy wave and transmit the electromagnetic energy utilized by the wireless power receiver system described herein. In embodiments, the wireless power transmitter system is configured to broadcast an electromagnetic energy wave into a general area, wherein the electromagnetic energy is transmitted with a beam width of less than 360° (for a unidirectional antenna), and less than 180° for a wall mounted or planer antennas. In other embodiments, the wireless power transmitter system is configured to transmit a directional electromagnetic energy beam to a location of a wireless power receiver. In embodiments, the beams are dynamically adjusted according to the distance of the wireless power receiver system from, the base charger, and/or the direction of movement of the intended wireless power receiver system. In embodiments, the broadcast electromagnetic energy beams directed to an intended area have a beam width of less than or equal to about 180°, or 90°, or 60°, or 55°, or 50°, or 45°, or 40°, or 35°, or 30°, or 25°. In embodiments, a directional electromagnetic energy beam has a beam width of less than or equal to about 20°, or 15°, 10°, or 5°.

In embodiments, the wireless power transmitter system is configured to transmit electromagnetic energy via broadcast and/or via one or more directional electromagnetic energy beams to a wireless power receiver system, and comprises antenna elements and associated circuitry, software and control systems for operating in frequency bands from about 20 KHz to about 50 KHz, and/or from about 150 MHz to about 900 MHz, and/or from about 900 MHz to about 1.8 GHZ, and/or from about 1.6 GHz to about 2.0 GHz, and/or from about 2.0 GHz to about 8.0 GHz, and/or from about 3 GHz to about 300 GHz. In embodiments, the wireless power transmitter system is configured to transmit electromagnetic energy in frequency bands around 900 MHZ, 2.5 GHZ, 5.250 GHz, or 5.8 GHz. In embodiments, the antenna elements and associated circuitry, software and control systems are configured for operating in frequency bands within the “5G” range which include low-band, mid-band or high-band millimeter-wavelengths having frequencies from about 24 GHz up to 54 GHz, and/or mid-band 5G using microwave wavelengths having frequencies from about 2.3-4.7 GHz, and/or high-band 5G wavelengths using frequencies of 24-47 GHz.

In embodiments, the wireless power transmitter system is configured to harvest electromagnetic energy provided as an infrared signal, a visible signal, an ultraviolet signal, an RF signal source, or a combination thereof.

In embodiments, the wireless power transmitter system according to one or more embodiments disclosed herein is configured to transmit electromagnetic energy which is harvestable by a corresponding wireless power receiver system over a distance of greater than about 10 cm, or 20 cm, or 30 cm, or 40 cm, or 50 cm, or 100 cm, or 5 m, or 10 m, or 50 m, wherein the wireless power receiver system is configured to harvest a portion of the is electromagnetic energy, convert the harvested energy into electrical energy, and direct the electrical energy into the electrical storage device.

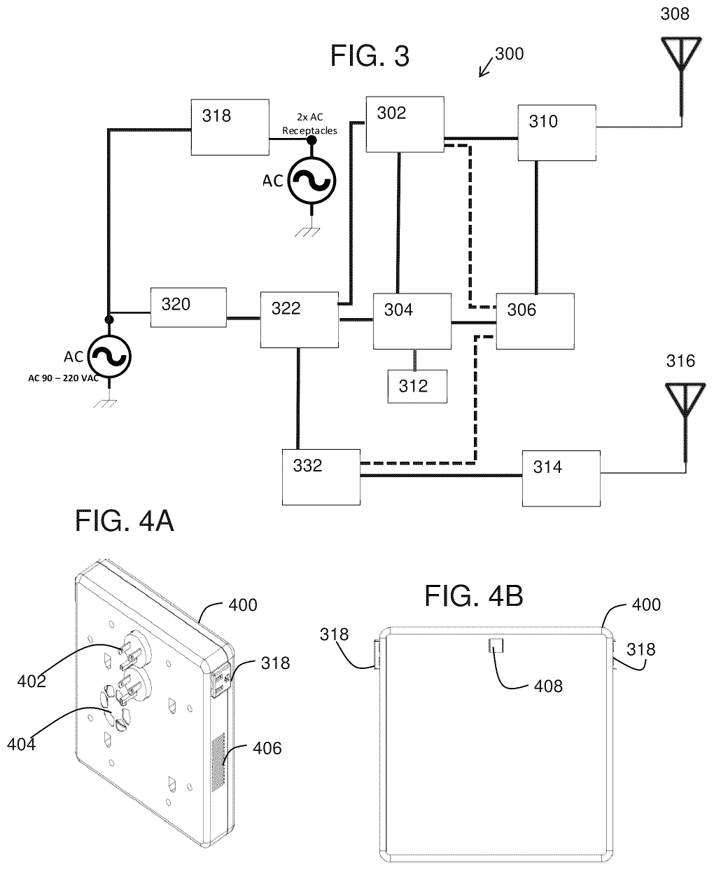

FIG. 3 depicts a block diagram of a wireless power transmitter system 300 according to embodiments disclosed herein. In an embodiment, the wireless power transmitter system 300 comprises a power amplifier 302, in electrical communication with a transmitter 304, comprising, or associated with an oscillator circuit 312, and which is in electronic communication with a transmitter controller 306 in electrical communication with an antenna 308 through a low pass filter 310. In embodiments, the transmitter controller 306 is configured to control the power amplifier 302, and/or other components of the system. In embodiments, the wireless power transmitter system 300 further comprises an AC/DC converter 320, in electrical communication with one or more DC/DC converters 322 which supply power to the power amplifier 302, the transmitter controller 306, and other components. In embodiments, the wireless power transmitter system 300 further includes a wireless electronic communication system 332, configured to provide electronic communication between the transmitter controller 306 and an external electronic device, and may be controlled by the transmitter controller 306. In embodiments, the wireless electronic communication system 332 is configured for wifi communication, serial communication, e.g., bluetooth, and/or the like. The wireless electronic communication system 332 may be in electronic communication with the antenna 308, or may include a matching circuit 314, and a separate or internal antenna 316.

In embodiments, the wireless power transmitter system may further comprises a male power input, engageable with a female electric mains power socket, the mail power input in electrical communication with at least one additional female electric mains power output socket 318 configured to receive a male power plug from an external electrically powered device.

As shown in the perspective view of FIG. 4A and the front on view of FIG. 4B, in embodiments, the wireless power transmitter system is disposed within a housing 400 configured with the male power inputs 402, dimensioned and arranged to plug into an electrical receptacle, which are further in electrical communication with one or more female electric mains power output sockets 318. In embodiments, the wireless power transmitter system further comprises a cooling fan 404, cooling fenestrations 406, an indicator or power light 408, and the like.

### Embodiments Listing

Embodiments of the instant disclosure include the following:

E1. A wireless power receiver system comprising:
a programable gain power amplifier configured to receive an energy input derived from the electromagnetic energy source and direct an amplified energy output signal into a power harvesting circuit within an optimal input range of the power harvesting circuit at which the amplified energy output signal is converted into DC current at an efficiency of greater than or equal to about 50%.

E2. The wireless power receiver system according to embodiment E1, wherein the programable gain power amplifier is configured to direct the amplified energy output signal into the power harvesting circuit within an optimal input range of the power harvesting circuit at which the amplified energy output signal is converted into DC current at an efficiency of greater than or equal to about 65%.

E3. The wireless power receiver system according to embodiments E1-E2, wherein the programable gain power amplifier is powered by an independent power source.

E4. The wireless power receiver system according to embodiments E1-E3, wherein the programable gain power amplifier is configured to receive the energy input derived from the electromagnetic energy source from an electromagnetic energy receiver configured to receive a wireless electromagnetic energy signal from an external power source physically separated from the electromagnetic energy receiver by a distance of greater than about 10 cm.

E5. The wireless power receiver system according to embodiment E4, wherein the electromagnetic energy receiver is configured to receive a directed power beam from the external power source.

E6. The wireless power receiver system according to embodiments E4-E5, wherein the electromagnetic energy receiver is in electrical communication with the energy input derived from the electromagnetic energy source of the programable gain power amplifier through an impedance matching network.

E7. The wireless power receiver system according to embodiments E1-E6, wherein the output of the power harvesting circuit is directed into an energy management circuit configured to direct electrical energy into an electrical storage device, the electrical storage device configured to output energy to an external electrical device through a wired electrical connection.

E8. The wireless power receiver system according to embodiment E7, wherein the electrical storage device comprises a battery.

E9. The wireless power receiver system according to embodiments E7-E8, wherein the electrical storage device comprises a capacitor.

E10. The wireless power receiver system according to embodiments E7-E9, wherein the energy management circuit is further configured to direct power into the independent power source of the programable gain power amplifier.

E11. A wireless power receiver system comprising:
an electromagnetic energy receiver configured to receive a wireless electromagnetic energy signal from an external power source physically separated from the electromagnetic energy receiver by a distance of greater than about 10 cm;
the electromagnetic energy receiver in electrical communication with an impedance matching network configured to output energy into an input of a programable gain power amplifier having an independent power source;
the programable gain power amplifier configured to direct an amplified energy output signal into a plurality of power harvesting circuits through a power divider circuit;
wherein a DC power output of each of a plurality of power harvesting circuits are combined and directed into an energy management circuit configured to direct the DC power into an electrical storage device;
the electrical storage device configured to output energy to an external electrical device through a wired electrical connection;
wherein the programable gain power amplifier is configured to produce the amplified energy output signal within an optimal input range of the power harvesting circuits at which the amplified energy output signal is converted into DC power at an efficiency of greater than or equal to about 50%.

E12. The wireless power receiver system according to embodiment E11, wherein the electrical storage device comprises a battery.

E13. The wireless power receiver system according to embodiments E11-E12, wherein the electrical storage device comprises a capacitor.

E14. The wireless power receiver system according to embodiments E11-E13, wherein the electromagnetic energy receiver is configured to receive a directed power beam from the external power source.

E15. The wireless power receiver system according to embodiments E11-E14 wherein the energy management circuit is further configured to direct power into the independent power source of the programable gain power amplifier.

E16. A wireless power bank comprising:
a plurality of wireless power receiver systems according to embodiments E1-E15, wherein the DC power output of each of a plurality of power harvesting circuits of each of the plurality of wireless power receiver systems are combined and directed into a single energy management circuit configured to direct the DC power into a single electrical storage device; or
the DC power output of each of the plurality of power harvesting circuits of each of the plurality of wireless power receiver systems are directed into an energy management circuit, each of the outputs of the energy management circuits are combined and directed into a single electrical storage device.

E17. A wireless power bank comprising:
a plurality of wireless power receiver systems, each comprising:
an electromagnetic energy receiver configured to receive a wireless electromagnetic energy signal from an external power source physically separated from the electromagnetic energy receiver by a distance of greater than about 10 cm;
the electromagnetic energy receiver in electrical communication with an impedance matching network configured to output energy into an input of a programable gain power amplifier having an independent power source;
the programable gain power amplifier configured to direct an amplified energy output signal into a plurality of power harvesting circuits through a power divider circuit;
wherein the programable gain power amplifier is configured to produce the amplified energy output signal within an optimal input range of the power harvesting circuits at which the amplified energy output signal is converted into DC power at an efficiency of greater than or equal to about 50%;
wherein: a DC power output of each of a plurality of power harvesting circuits of each of the plurality of wireless power receiver systems are combined and directed into a single energy management circuit configured to direct the DC power into a single electrical storage device;
wherein the electrical storage device is configured to output energy to an external electrical device through a wired electrical connection.

E18. A wireless power bank comprising:
a plurality of wireless power receiver systems, each comprising:
an electromagnetic energy receiver configured to receive a wireless electromagnetic energy signal from an external power source physically separated from the electromagnetic energy receiver by a distance of greater than about 10 cm;
the electromagnetic energy receiver in electrical communication with an impedance matching network configured to output energy into an input of a programable gain power amplifier having an independent power source;
the programable gain power amplifier configured to direct an amplified energy output signal into a plurality of power harvesting circuits through a power divider circuit;
wherein the programable gain power amplifier is configured to produce the amplified energy output signal within an optimal input range of the power harvesting circuits at which the amplified energy output signal is converted into DC power at an efficiency of greater than or equal to about 50%;
wherein the DC power output of each of the plurality of power harvesting circuits of each of the plurality of wireless power receiver systems are directed into an energy management circuit, each of the outputs of the energy management circuits are combined and directed into a single electrical storage device;
wherein the electrical storage device is configured to output energy to an external electrical device through a wired electrical connection.

E19. The wireless power bank according to embodiments E16-E18, wherein the electrical storage device comprises a battery.

E20. The wireless power bank according to embodiments E16-E19, wherein the electrical storage device comprises a capacitor.

E21. The wireless power bank according to embodiments E16-E20, wherein each electromagnetic energy receiver is configured to receive a directed power beam from the external power source.

E22. The wireless power bank according to embodiments E16-E21, wherein the energy management circuit is further configured to direct power into the independent power source of each of the programable gain power amplifiers.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A wireless power system comprising:
a wireless power transmitter configured to transmit electromagnetic energy over a distance of greater than about 10 cm to a wireless power receiver, the wireless power receiver configured to receive a portion of the electromagnetic energy and convert the electromagnetic energy into electrical energy and direct the electrical energy into a power storage device;
the wireless power transmitter comprising a power amplifier, a transmitter controller and transmitter configured to transmit the electromagnetic energy to the wireless power receiver;
the wireless power receiver comprising a receiver controller in electronic communication with a programable gain power amplifier configured to receive an energy input received from the wireless power transmitter and direct an amplified energy output signal into a power harvesting circuit within an input range of the power harvesting circuit at which the amplified energy output signal is converted into a DC current at an efficiency of greater than or equal to about 50%.

2. The wireless power system of claim 1, wherein the programable gain power amplifier is configured by the receiver controller to direct the amplified energy output signal into the power harvesting circuit within an optimal input range of the power harvesting circuit at which the amplified energy output signal is converted into DC current at an efficiency of greater than or equal to about 65%.

3. The wireless power system of claim 1, wherein the programable gain power amplifier is powered by an independent power source.

4. The wireless power system of claim 3, wherein the receiver controller is further configured to direct power into the independent power source of the programable gain power amplifier.

5. The wireless power system of claim 1, wherein the wireless power transmitter broadcasts electromagnetic energy over an arc of less than or equal to about 180°.

6. The wireless power system of claim 1, wherein the wireless power transmitter transmits a directed power beam of electromagnetic energy and wherein the wireless power receiver is configured to receive the directed power beam of electromagnetic energy from the wireless power transmitter.

7. The wireless power system of claim 1, wherein the wireless power receiver comprises an energy receiver in electrical communication with the programable gain power amplifier through an impedance matching network.

8. The wireless power system of claim 1, wherein the output of the power harvesting circuit is directed into an energy management circuit configured to direct electrical energy into an electrical storage device, the electrical storage device configured to output energy to an external electrical device through a wired electrical connection.

9. The wireless power system of claim 8, wherein the electrical storage device comprises a battery.

10. The wireless power system of claim 8, wherein the electrical storage device comprises a capacitor.

11. The wireless power system of claim 1, wherein the wireless power transmitter comprises a male power input, engageable with a female electric mains power socket, the male power input in electrical communication with at least one additional female electric mains power output socket configured to receive a male power plug from an external electrically powered device.

12. The wireless power system of claim 1, wherein the wireless power transmitter, the wireless power receiver, or both, further comprise a wireless electronic communication system configured for wireless electronic communication between an external device and the wireless power transmitter and/or the wireless power receiver, and/or between the wireless power transmitter and the wireless power receiver.

13. The wireless power system of claim 12, wherein the wireless electronic communication system is configured to provide electronic communication between the wireless power transmitter and another wireless power transmitter.

14. The wireless power system of claim 12, wherein the wireless electronic communication system comprises a wireless serial communication system configured for bluetooth serial communication, wifi communication, or both.

15. A wireless power receiver system comprising:
an electromagnetic energy receiver controlled by a receiver controller, configured to receive a wireless electromagnetic energy signal from an external power source physically separated from the electromagnetic energy receiver by a distance of greater than about 10 cm;
the electromagnetic energy receiver in electrical communication with an impedance matching network configured to output energy into an input of a programable gain power amplifier having an independent power source;
the programable gain power amplifier configured to direct an amplified energy output signal into a plurality of power harvesting circuits through a power divider circuit;
wherein a DC power output of each of a plurality of power harvesting circuits are combined and directed into an energy management circuit controlled by the receiver controller, configured to direct the DC power into an electrical storage device;
the electrical storage device configured to output energy to an external electrical device through a wired electrical connection;
wherein the programable gain power amplifier is configured to produce the amplified energy output signal within an optimal input range of the power harvesting circuits at which the amplified energy output signal is converted into DC power at an efficiency of greater than or equal to about 50%.

16. The wireless power receiver system of claim 15, comprising a plurality of wireless power receiver systems, each configured to output electrical energy to a single electrical energy storage device.

17. The wireless power receiver system of claim 15, wherein the receiver controller is further configured to direct power into the independent power source of the programable gain power amplifier.

18. The wireless power receiver system of claim 15 further comprising a wireless electronic communication system in electronic communication with the receiver controller, configured to provide wireless electronic communication between the wireless power receiver and an external device.

19. A wireless power transmitter system, comprising:
a power amplifier in electrical communication with a transmitter in electronic communication with a transmitter controller, and in electrical communication with an antenna through a low pass filter, wherein the wireless power transmitter comprises a male power input, engageable with a female electric mains power socket, the male power input in electrical communication with at least one additional female electric mains power output socket configured to receive a male power plug from an external electrically powered device.

20. The wireless power transmitter system of claim 19, further comprising a wireless electronic communication system configured to provide wireless electronic communication between the wireless power transmitter and an external device;
Between the wireless power transmitter and a wireless power receiver; and/or
between the wireless power transmitter and another wireless power transmitter.
